(19) United States
(12) Patent Application Publication
(10) Pub. No.: US 2010/0296879 A1
(43) Pub. Date: Nov. 25, 2010

(54) SYSTEM TO TRANSPORT SOLIDS IN LIQUID MEDIA

(75) Inventors: Michael John STEAD FAILLE, Santiago (CL); Peter Herbert BURGER, Santiago (CL)

Correspondence Address: HAMRE, SCHUMANN, MUELLER & LARSON, P.C., P.O. BOX 2902, MINNEAPOLIS, MN, 55402-0902, US

(73) Assignee: ANDESOCEAN S.A., Santiago (CL)

(21) Appl. No.: 12/548,901

(22) Filed: Aug. 27, 2009

(30) Foreign Application Priority Data
May 19, 2009 (CL) 1234-2009

(51) Int. Cl. B65G 53/34; B60P 1/60

(52) U.S. Cl. 406/39

(57) ABSTRACT

A system to transport solids in liquid media, especially in the field of maritime and land transportation of fruits or vegetables in the agricultural produce area, or of any product having to be transported in liquid media for their protection against environment and the medium.

### FIELD OF THE INVENTION

The present invention relates to a means to transport solids in liquid media, especially in the field of maritime and land transportation of fruits or vegetables in the agricultural produce area, or of any product having to be transported in liquid media for their protection against environment and the medium.

### DESCRIPTION OF THE PRIOR ART

Presently, the transportation of fruits and vegetables that must be necessarily be moved within a liquid medium is carried out by manually placing said fruits and vegetables (or any other product as indicated in the foregoing paragraph) in such vessels as cans, buckets, plastic ibc containers, along with a liquid generally containing preserving and/or flavoring substances, by way of a funnels or manual vessels that get the content to the mouth of each vessel, then each of these containers is covered and, then, loaded, one by one, onto a truck or another means of transportation by loaders or pallet jacks or forklifts, the containers being carefully loaded and tied in order to prevent the containers from dumps and spills upon arriving at their destination, for example, at a packaging plant. The vessels are again unloaded from the truck by loading operators, pallet jacks or forklifts) and moved to the processing area, where the content is again removed from the vessels for being transferred to the production line.

### SUMMARY OF THE INVENTION

The present invention provides a method of transporting fruits and vegetables and other products that must be necessarily stored and transported in protecting liquid media. This invention provides a novel solution comprising the use of a flexible tank that is introduced, empty, into in a container or tank car, the flexible tank being filled through a special opening located on its top and, the tank adapting itself to the inner contours of the marine container or tank car as it fills up until the solid-liquid mixture fills up the flexible tank, thus allowing a more rational use of loading space within the marine container or tank car, since the loading capacity would be increased with respect to the traditional method as described above, mainly because it prevents the typical interstices that necessarily form when using vessels, the volume of solid loaded being increased by 30% approximately.

On the other hand, the saving of labor related to loading and unloading is apparent, since the vessels do not have to be, one by one, be filled with the solid-liquid mixture; then close them, one by one, on the truck; then be opened and unloaded inside the processing area. The total cost of packing materials decreased considerably, as do the volume, weight and the handling of wastes from these materials.

Once the container has arrived, with the flexible bag in its interior, at its destination, its solid-liquid content is emptied by way of one or several exits located at the bottom or top of the flexible bag, preferably at the bottom of its side walls. To that purpose, a system adequate to each kind of product to be unloaded is used.

### BRIEF DESCRIPTION OF THE DRAWINGS

FIG. 1 shows the flexible bag when its filling is about to start, when an amount of liquid is injected to it in order to start the process.

FIG. 2 shows the flexible bag inside the container when it is being filled.

FIG. 3 shows the flexible bag inside the container during transportation.

FIG. 4 shows the flexible bag inside the container during the unloading process.

### DETAILED DESCRIPTION OF THE INVENTION

The invention operates as follows:

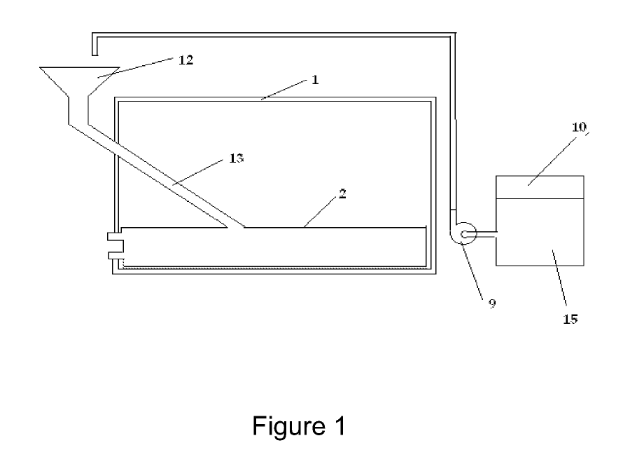

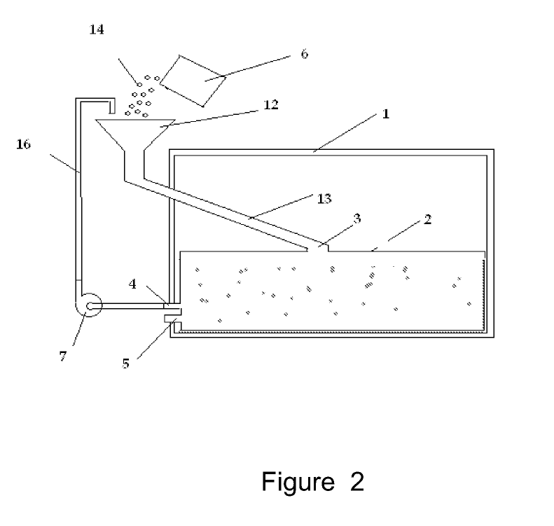

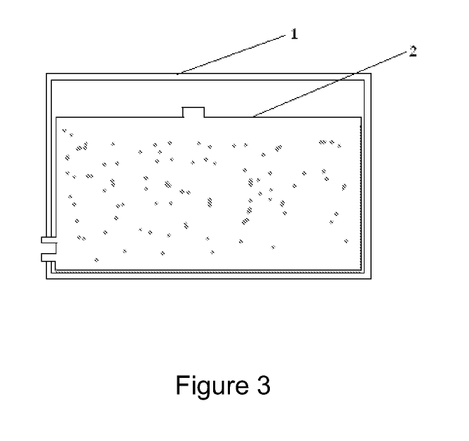

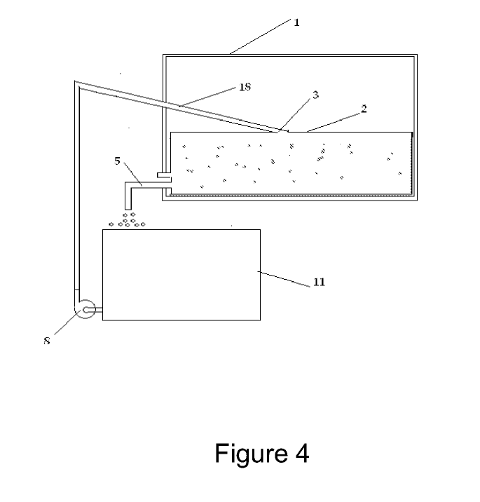

A flexible tank (2) is placed inside a marine container or tank car (1) specifically on the floor of said container. The empty flexible bag is ideally laid on the entire floor of said container (1), care being taken that the floor of the marine (container or of the tank car (1) is free of sharp edges or elements that might tear or damage the bag when expanding as a result of the solid and/or liquid content it will be filled with. At an initial stage, as shown in FIG. 1, the liquid that will form the liquid part of the solid-liquid content is injected. To this effect, an external supply, such as the regular supply line or an external tank (10), is used, from which the liquid is pumped, by means of a pump (9), or any other means of liquid supply, to the flexible tank (2); the liquid is injected through the top liquid-solid intake (3) that is located on the top side of the flexible tank or at the bottom intake (4). Once the liquid content has been fully loaded, the external tank (19) and the pump (9) are disconnected, the filling of the flexible tank (2) being started, this process being able to be carried out together with the loading of solids into the flexible tank (2). To this effect, as is shown in FIG. 2, a feeding pipe (13), as well as top intake of the flexible tank (3) is introduced through the funnel (12) or via any system as required to load the specific product, as shown in FIG. 2, or through the bottom intake of the flexible tank (3) or through the bottom intake (4) the solid material (14), together with the liquid (15) that is removed by way of a pump or any other system, from a bottom outlet (4) located in the flexible tank, and is transported through a transportation pipe (16) to said funnel (12, silo or another suitable system for the product that is being loaded). Once the optimum filling level in the flexible tank (2) has been reached, all of the elements outside the container or tank car (1) and connected to the flexible tank (2) are removed, all of the intakes and outlets previously used being closed, thus the container or tank car (1) being ready to be transported as shown in FIG. 3. Once the container has reached its destination, it is unloaded as shown in FIG. 4. To this effect, liquid is retrieved from a target tank (11) wherein the solid-liquid content retrieved from the flexible bag (2) will be stored by setting up a pump (8) or the system that has been included for the specific product from the bottom outlet of the target tank (11) and will be injected into the top intake (3) by way of a hose (18) to assist the transportation of solids contained inside the flexible tank (2), the solid-liquid content of the flexible tank (2) exist through the bottom outlet (5) until its content is fully discharged into the target tank (11), which may also be another vessel where said content remains available for processing. Finally, the flexible tank (2) is removed empty from the interior of the container or tank car (1) being broken to remove any remains of the content that may have remained inside it. Then, the flexible tank (2) is disposed of. This system may have a heating system allowing to heat the liquid medium (that solidifies or otherwise) to facilitate the protecting medium (preserver) to flow together with the product that must be transported and protected.

What is claimed:

1. A system used to transport solids in liquid media that is installed inside a marine container or tank car WHEREIN a flexible tank comprises:
at least an intake on its top portion to pump in solids, liquids, or a mixture thereof into said flexible tank.
at least an outlet at its bottom part allowing to discharge solids and liquids.
at least one outlet at its bottom section allowing the discharge or recirculation of liquids.

2. The system to transport solids in liquid media that is installed inside a container, according to claim 1, WHEREIN the flexible tank is located inside said container or tank car.

3. The system to transport solids in liquid media that is installed inside a container, according to claim 1, WHEREIN the flexible tank takes the form of the interior of the container or tank car.

4. The system to transport solids in liquid media that is installed inside a container, according to claim 1, WHEREIN said at least one top intake is used to pump in a solid and a liquid during the loading and a liquid during the unloading.

5. The system to transport solids in liquid media that is installed inside a container, according to claim 1, WHEREIN at least one of said bottom outlet is used to re-circulate liquid during loading and/or unloading.

6. The system to transport solids in liquid media that is installed inside a container, according to claim 1, WHEREIN another one of the at least said bottom outlets is used to discharge the liquid/solid that is transported.

7. The system to transport solids in liquid media that is installed inside a container, according to claim 1, WHEREIN it may have a heating system allowing to heat the liquid medium (which solidifies or otherwise) to allow the protective medium (preserver) to flow along with the product that is to be transported and protected.

8. A method of using a system to transport solids in liquid media comprising the following steps:
At loading point:
Providing a container;
providing a flexible tank;
providing a medium to load the solids;
filling the flexible tank with the liquid that will be transported, along with the solid, by means of a pump and an external tank;
disconnecting the pumping system and external tank once the required amount of liquid has been filled up;
connecting a hose to a bottom outlet in the flexible tank to pump in liquid, which is poured through the top intake;
providing solids that are poured simultaneously with the liquid of the previous step through the top intake;
Once the maximum level of the flexible bag has been reached, the pump is removed, the intake sealed, the top feeding piping removed, and the intake sealed; transport;
At the unloading point;
connecting a pump to a bottom outlet of the target tank and to the top intake of the Flexible tank;
opening the tank's bottom outlet for unloading;
pumping liquid from the bottom outlet of the target tank to the top intake of the flexible tank to help discharging the liquid-solid mixture through the bottom outlet of the flexible tank;
once the discharge has been completed, the target tank's outlet circuit-pump-flexible tank's top intake must be dismounted;
removing the flexible bag from the marine container or tank car and retrieve the content that may have remained inside the tank,
disposing of the flexible tank.
